(19) United States
(12) Patent Application Publication
(10) Pub. No.: US 2026/0355783 A1
(43) Pub. Date: Nov. 12, 2026

(54) PREPARATION OF A COMPOSITE ORGANOGEL LUBRICATING COATING FOR MARINE ANTIFOULING AND ANTICORROSION APPLICATIONS

(71) Applicant: Zhejiang University, Hangzhou (CN)

(72) Inventors: Weiqi FU, Hangzhou (CN); Mengsheng XIA, Hangzhou (CN)

(73) Assignee: Zhejiang University, Hangzhou (CN)

(21) Appl. No.: 19/647,826

(22) Filed: Apr. 14, 2026

(30) Foreign Application Priority Data
May 12, 2025 (CN) 202510602459.7

(51) Int. Cl. B05D 7/00; B05D 1/18; B05D 3/10; C08J 3/24; C09D 5/08; C09D 5/16; C09D 151/08

(52) U.S. Cl. CPC B05D 7/546; B05D 1/18; B05D 3/108; C08J 3/246; C09D 5/08; C09D 5/1668; C09D 5/1675; C09D 151/085; B05D 2202/15; B05D 2203/35; B05D 2256/00; B05D 2401/21; B05D 2401/31; B05D 2518/12; C08J 2329/04; C08J 2383/04

(57) ABSTRACT

A composite organogel lubricating coating for marine antifouling and anticorrosion, a preparation method, and use are disclosed. The method includes: (1) dissolving poly(vinyl alcohol) and tannic acid in an ethanol/water solution to obtain a hydrogel casting solution; immersing a substrate in the hydrogel casting solution, cooling to fix the coating, and thermally crosslinking to obtain a gel coating; (2) mixing a vinyl-functional siloxane monomer, a vinyl-functional silicone oil, and a hydrosilane crosslinker and adding a platinum catalyst to promote hydrosilylation to obtain an organogel casting solution; and (3) coating the organogel casting solution onto the gel coating, curing, and injecting a lubricating liquid into the cured coating to obtain the composite organogel lubricating coating. The composite coating exhibits excellent stretchability, wear resistance, and multiple antifouling functions, and shows promising application potential for antifouling and anticorrosion of ship hull surfaces.

### RELATED APPLICATIONS

This application claims priority to and the benefit of Chinese Patent Application No. 202510602459.7, filed May 12, 2025, entitled “Composite Organogel Lubricating Coating for Marine Antifouling and Anticorrosion, Preparation Method, and Application.” The entire contents of the foregoing application are incorporated herein by reference in their entirety to the extent permitted by law.

### COPYRIGHT NOTICE

A portion of the disclosure of this patent document contains material that is subject to copyright protection. The copyright owner has no objection to the facsimile reproduction by anyone of the patent document or the patent disclosure, as it appears in the records of the United States Patent and Trademark Office, but otherwise reserves all copyright rights whatsoever.

### TECHNICAL FIELD

The present disclosure relates to marine antifouling and anticorrosion coatings and, more particularly, to a method for preparing a composite organogel lubricating coating for marine antifouling and anticorrosion applications, and to the coating and uses thereof.

### BACKGROUND

Marine biofouling control is a long-standing and critical issue in the fields of shipping and offshore engineering. With the growth of global trade and marine resource exploitation, vessels and marine equipment are frequently exposed to seawater for extended periods, resulting in severe biofouling. Biofouling increases hydrodynamic drag, reduces navigation efficiency, elevates fuel consumption, and accelerates corrosion of hull materials, thereby shortening service life and increasing operating costs.

Conventional antifouling paints commonly contain heavy metals or organotin compounds and inhibit organism attachment by releasing harmful substances. Such toxic substances can cause serious marine ecological pollution and have been prohibited in various countries and regions. Low-surface-energy antifouling coatings (e.g., silicone-based systems) can reduce adhesion by lowering surface energy, but may suffer from limited effectiveness and poor long-term durability. Self-polishing antifouling coatings can maintain a smooth surface by continuously releasing antifouling agents; however, the release rate may be difficult to control, and the antifouling agent can be depleted during long-term service. Accordingly, there remains a need for a novel, non-toxic, and environmentally friendly antifouling coating technology.

In recent years, to address the needs of green technology and sustainable development, various surface coating strategies have been developed, such as slippery liquid-infused porous surfaces (SLIPS) and lubricant-infused polymer surfaces (LLS). However, SLIPS can suffer from lubricant loss, and LLS can face insufficient durability, which may result in severe lubricant depletion from lubricant-infused surfaces. Therefore, in the antifouling field, there is a continuing need to develop an improved lubricating-coating approach to ensure long-term and effective antifouling performance in marine environments.

### SUMMARY

The present disclosure addresses the foregoing needs by providing a composite organogel lubricating coating, a method for preparing the coating, and the use of the coating for marine antifouling and anticorrosion. In a first aspect, a method for preparing a composite organogel lubricating coating is provided, comprising:

(S1) dissolving poly(vinyl alcohol) (PVA) and tannic acid (TA) in an ethanol/water solution with heating to obtain a hydrogel casting solution; immersing a cleaned substrate in the hydrogel casting solution, removing the substrate and cooling to fix the hydrogel, followed by thermal crosslinking until water is substantially removed to form a gel coating;

(S2) mixing a vinyl-functional siloxane monomer, a vinyl-functional silicone oil, and a hydrosilane crosslinker containing Si-H bonds, and adding a platinum catalyst to promote hydrosilylation to obtain an organogel casting solution;

(S3) uniformly applying the organogel casting solution onto the gel coating obtained in (S1), removing excess organogel casting solution and curing to form an organogel layer; injecting a lubricating liquid into the cured coating and removing excess lubricating liquid to obtain the composite organogel lubricating coating.

In certain embodiments, the mass ratio of PVA to TA in (S1) is 3:(1 to 4). In certain embodiments, the volume ratio of ethanol to water in the ethanol/water solution is (4 to 6):(6 to 4). In certain embodiments, the cooling in (S1) is performed at about -80° C. In certain embodiments, the thermal crosslinking in (S1) is performed at about 40° C to about 80° C for about 0.5 hour to about 1 hour.

In certain embodiments, the vinyl-functional siloxane monomer in (S2) comprises vinyltrimethoxysilane; the vinyl-functional silicone oil comprises vinyl-terminated polydimethylsiloxane; and the hydrosilane crosslinker comprises polymethylhydrosiloxane. In certain embodiments, the mass ratio of vinyl-terminated polydimethylsiloxane:polymethylhydrosiloxane:vinyltrimethoxysilane is 12:20:(1 to 4), and the mass ratio of platinum catalyst to polymethylhydrosiloxane is 1:(80 to 120).

In certain embodiments, curing in (S3) is performed at about 25° C to about 40° C for about 12 hours to about 24 hours. In certain embodiments, the lubricating liquid comprises polydimethylsiloxane (PDMS), a perfluoropolyether, and/or a silicone oil.

In a second aspect, a composite organogel lubricating coating prepared by any of the methods described herein is provided.

In a third aspect, the composite organogel lubricating coating is used on a ship hull or other marine-exposed surface to provide antifouling and anticorrosion functions.

In some embodiments, the composite coating provides one or more of the following advantages:
(1) A gradient-coupling strategy in combination with a phase-change-induced polymerization process may be used to adhere a silane-dominant organogel to a hydrogel surface dominated by hydrophilic polymers (PVA/TA). Silane hydrolysis and condensation enable confined in situ grafting at the water/organic interface, forming a highly entangled organogel network exhibiting superlubricity. The resulting coating can exhibit excellent stretchability, wear resistance, and multiple antifouling mechanisms.
(2) The disclosed method provides a useful reference for developing lubricant-infused organogel coatings and demonstrates promising application potential for long-term antifouling and anticorrosion of ship hull surfaces.

### BRIEF DESCRIPTION OF THE DRAWINGS

The accompanying drawings, which are incorporated in and constitute a part of this specification, illustrate certain embodiments of the present disclosure and, together with the description, serve to explain the principles of the disclosure.

FIG. 1A is a cross-sectional scanning electron microscopy (SEM) image of a glass-fiber filter membrane; and FIG. 1B is a cross-sectional SEM image of a gel coating prepared in Comparative Example 1.

FIG. 2 is a cross-sectional SEM image of a composite organogel lubricating coating prepared in Example 1.

FIG. 3 is a schematic diagram of water contact angle measurement of the composite organogel lubricating coating prepared in Example 1.

FIG. 4 shows tensile test results of the glass-fiber filter membrane, the gel coating prepared in Comparative Example 1, and the composite organogel lubricating coating prepared in Example 1.

FIG. 5A shows surface coverage results of Escherichia coli and Staphylococcus aureus on different glass slides in Example 2; and FIG. 5B shows the corresponding antibacterial rate results.

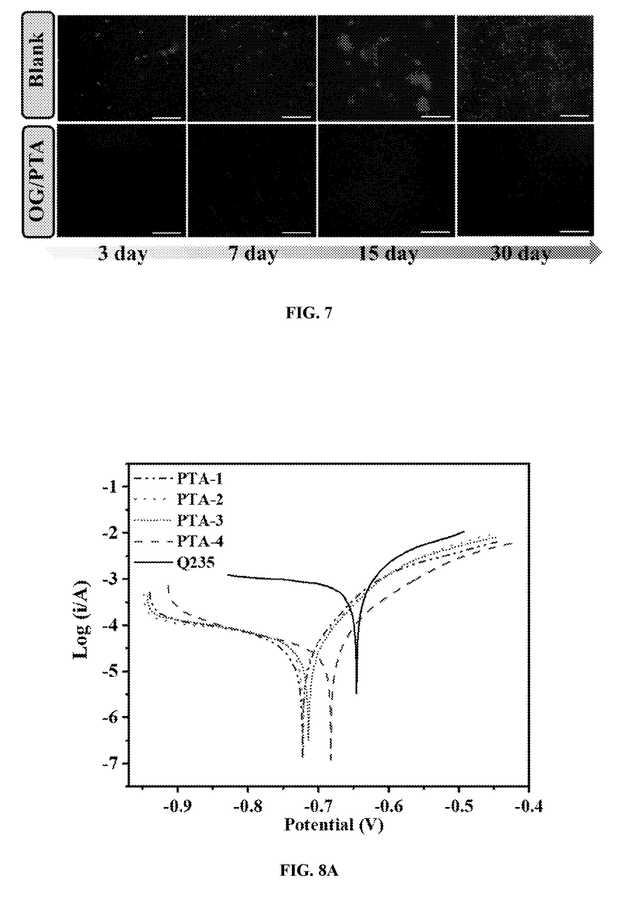

FIG. 6 shows surface coverage results of Phaeodactylum tricornutum on different glass slides in Example 3.

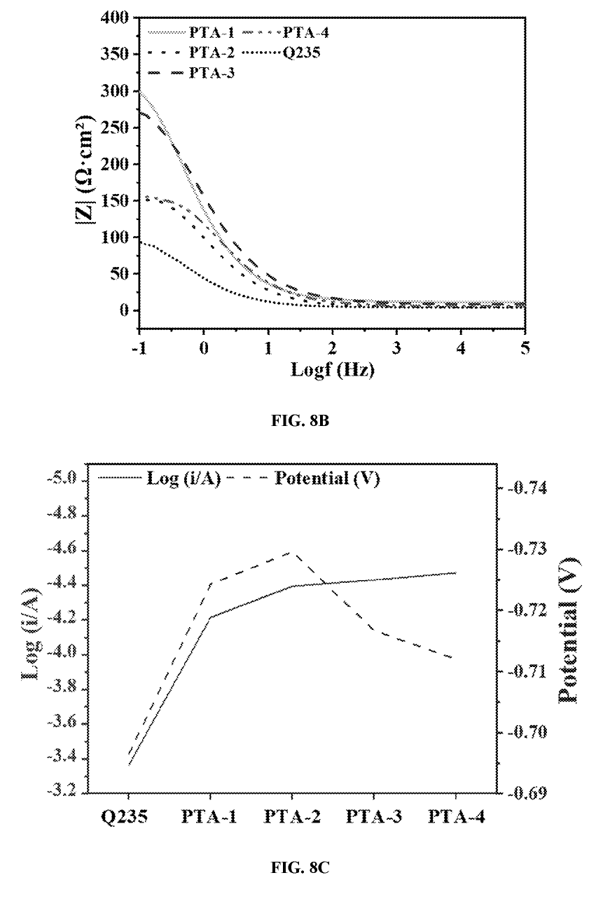

FIG. 7 shows fluorescence microscopy images of Phaeodactylum tricornutum on different glass slides in Example 3.

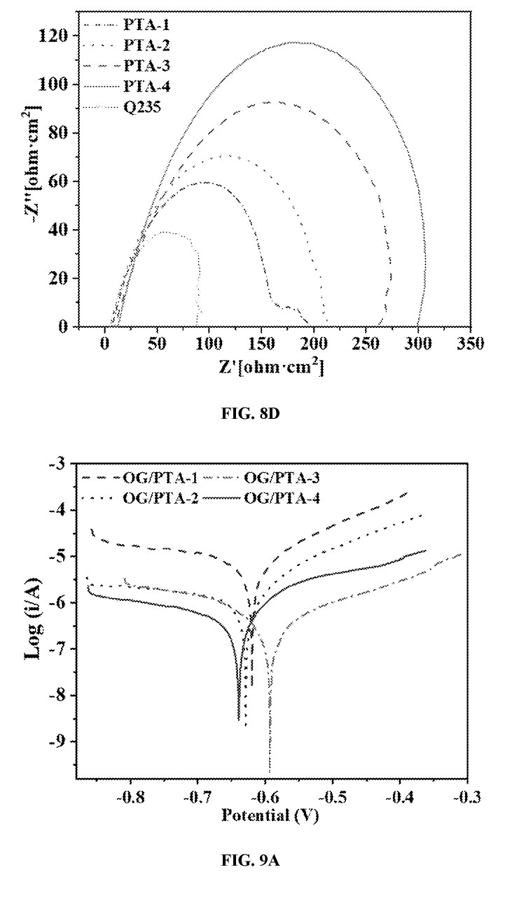

FIGS. 8A-8D shows corrosion-performance test results of gel coatings with different poly(vinyl alcohol) (PVA) to tannic acid (TA) ratios in Example 4, wherein FIG. 8A shows Tafel polarization curves, FIG. 8B shows electrochemical impedance spectroscopy (EIS) plots, FIG. 8C shows fitted corrosion current density and corrosion potential results, and FIG. 8D shows Nyquist plots.

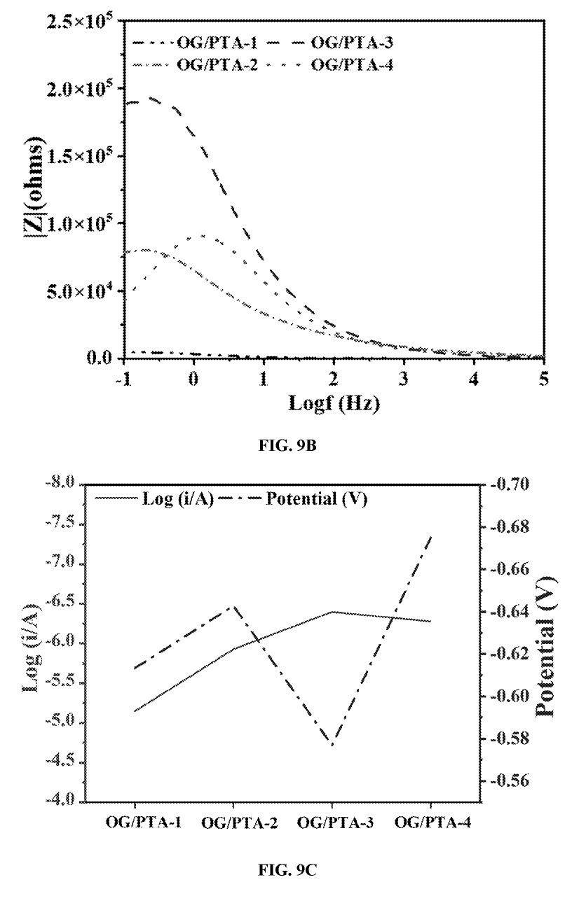

FIGS. 9A-9D shows corrosion-performance test results of different composite organogel lubricating coatings in Example 8, wherein FIG. 9A shows Tafel polarization curves, FIG. 9B shows EIS plots, FIG. 9C shows fitted corrosion current density and corrosion potential results, and FIG. 9D shows Nyquist plots.

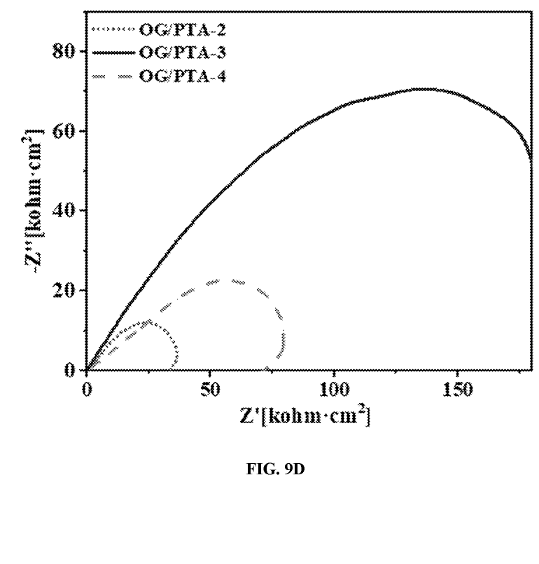

FIGS. 10A-10B shows corrosion-performance comparison results among OG/PTA-3, PTA-4, and Q235 steel in Example 8, wherein FIG. 10A shows Tafel polarization curves and FIG. 10B shows fitted corrosion current density and corrosion potential results.

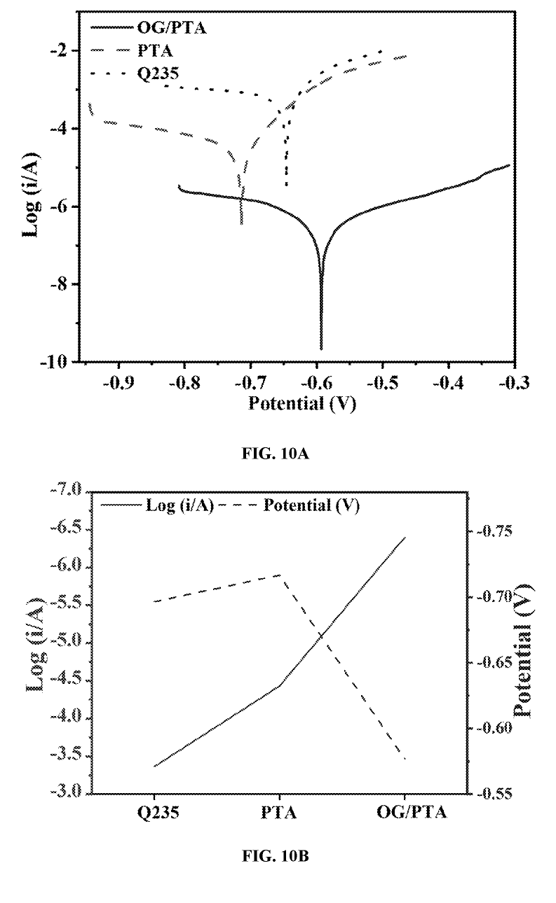

### DETAILED DESCRIPTION

### 1. Technical Field

The present invention relates to marine anti-fouling coatings, and more particularly to a composite organogel-based lubricating coating for marine anti-fouling and anti-corrosion, a preparation method thereof, and applications thereof.

### 2. Overview of the Invention

To address the limitations of conventional anti-fouling strategies (e.g., toxicity of biocide-releasing paints and durability issues of lubricant-infused surfaces), the invention provides a non-toxic, environmentally friendly composite organogel lubricating coating capable of providing multi-modal anti-fouling and anti-corrosion performance in marine environments.

In one aspect, the invention employs a gradient-coupling strategy and a phase-change-induced polymerization process. A hydrophilic hydrogel layer (based on poly(vinyl alcohol), PVA, and tannic acid, TA) is first formed and tightly adhered to a substrate. Subsequently, an organogel layer is formed on the hydrogel surface through a hydrosilylation addition reaction of vinyl-containing siloxane components with Si-H crosslinkers, promoted by a platinum catalyst. Lubricant is then introduced into the cured surface to obtain a lubricating composite coating with enhanced durability, mechanical performance, and multi-fouling resistance.

### 3. Definitions and Abbreviations for clarity

Unless otherwise specified:

“PTA” refers to the hydrogel layer derived from PVA and TA.

“OG” refers to the organogel layer derived from vinyl-terminated polydimethylsiloxane (V-PDMS), poly(methylhydrosiloxane) (PHMS), and a vinyl silane monomer such as vinyltrimethoxysilane (VTMS).

“OG/PTA” refers to the composite organogel-on-hydrogel coating.

“Lubricant” refers to a liquid introduced into/onto the cured coating surface, such as PDMS, perfluoropolyether (PFPE), or silicone oil.

### 4. Structure of the Composite Coating

The composite coating comprises (i) a hydrogel layer formed on a substrate surface and (ii) an organogel layer formed on the hydrogel layer, wherein the interfacial region can undergo confined in situ grafting/entanglement to provide robust adhesion and lubricity. The resulting surface exhibits “superlubricity”-related behavior, improved wear resistance, and multi-fouling resistance.

### 5. Preparation Method S1 - S3

### Step S1: Preparation of Hydrogel Casting Solution and Hydrogel Layer Formation

PVA and TA are added into an ethanol solution and heated until fully dissolved to obtain a hydrogel casting solution. A cleaned substrate is immersed in the hydrogel casting solution, removed and cooled for fixation, and then subjected to thermal crosslinking until moisture is fully evaporated to form a hydrogel coating layer.

In preferred embodiments:

The mass ratio of PVA to TA is 3:(1-4).

The volume ratio of ethanol to water in the ethanol solution is (4-6):(6-4).

Cooling fixation is carried out at −80° C.

Thermal crosslinking is performed in an oven at 40-80° C for 0.5-1 h (e.g., 60° C for 0.5 h in the examples).

### Step S2: Preparation of Organogel Casting Solution

A vinyl-containing siloxane monomer, a vinyl-containing silicone oil, and a Si–H-containing silane crosslinker are mixed, and a platinum catalyst is added to promote the addition (hydrosilylation) reaction, thereby obtaining an organogel casting solution.

In preferred embodiments:

The vinyl-containing siloxane monomer is VTMS.

The vinyl-containing silicone oil is vinyl-terminated PDMS (V-PDMS).

The Si–H-containing crosslinker is PHMS.

A mass ratio of V-PDMS:PHMS:VTMS is 12:20:(1–4).

The platinum catalyst dosage relative to PHMS is 1:(80–120).

### Step S3: Formation of Composite Coating and Lubricant Infusion

The organogel casting solution obtained in Step S2 is uniformly applied to the hydrogel layer obtained in Step S1. Excess organogel casting solution is removed, followed by curing. After curing, lubricant is introduced (injected/infused) onto/from the coating surface; excess lubricant is removed to obtain the composite organogel lubricating coating.

In preferred embodiments:

Curing is performed in an oven at 25–40° C for 12–24 h (e.g., 40° C for 12 h in the examples).

The lubricant is selected from PDMS, PFPE, or silicone oil.

### 6. Substrates and Applications

The substrate may be, for example, a glass fiber membrane (GF) or Q235 steel as demonstrated in the examples. The composite coating is particularly suitable for anti-fouling and anti-corrosion protection on ship hull surfaces and related marine engineering surfaces.

### 7. Brief Description of the Drawings for reference in this section

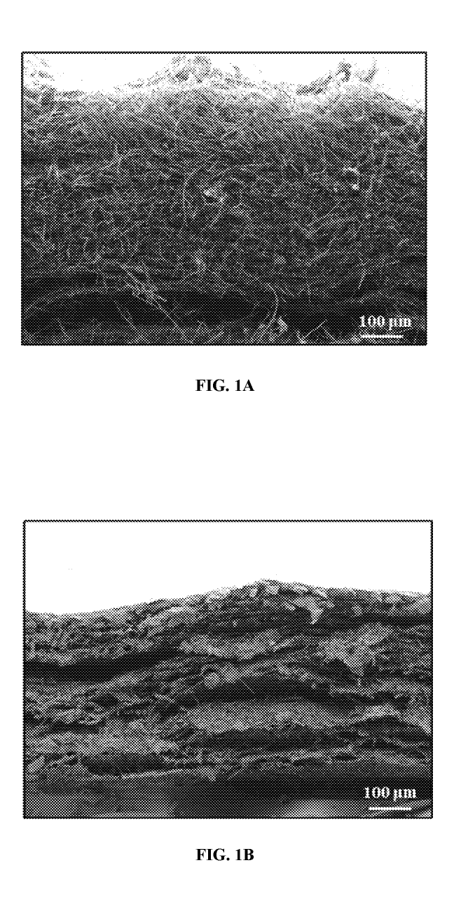

FIGS. 1 - 10 illustrate cross-sectional SEM images, wetting characterization, mechanical testing, bacterial and algal fouling evaluation, and electrochemical corrosion testing results for different samples and formulations.

### 8. Exemplary Embodiments

Example 1 Preparation on Glass Fiber Membrane
(i) Hydrogel casting solution: 3 g PVA + 4 g TA in 100 mL ethanol/water (1:1), heated at 95° C until fully dissolved.
(ii) Hydrogel layer formation: GF immersed, fixed at −80° C, then thermally crosslinked at 60° C for 0.5 h until moisture evaporated; swollen in water for 5 min and stored at −80° C.
(iii) Organogel casting solution: in a pre-cooled dish, 60 mg V-PDMS + 100 mg PHMS + 15 mg VTMS, mixed then 1 mg Pt catalyst added; used within 30 min.
(iv) Composite coating: OG applied on hydrogel surface, vertically hung to remove excess, cured at 40° C for 12 h; PDMS lubricant infused and excess removed to obtain GF-OG/PTA.

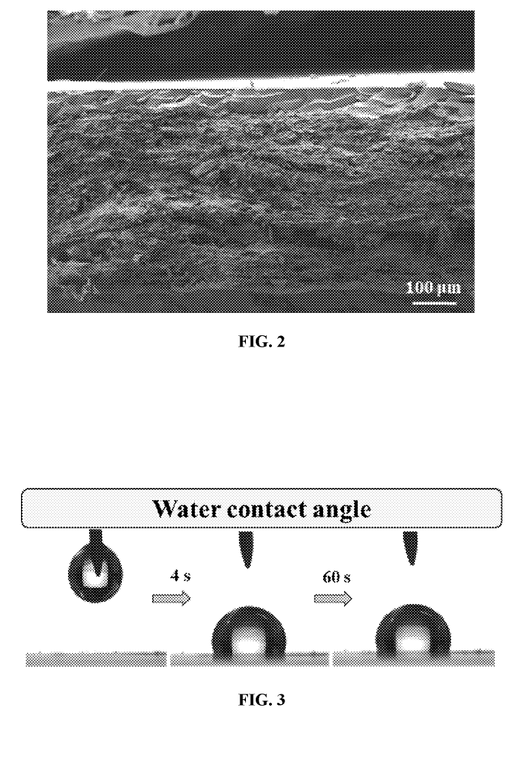

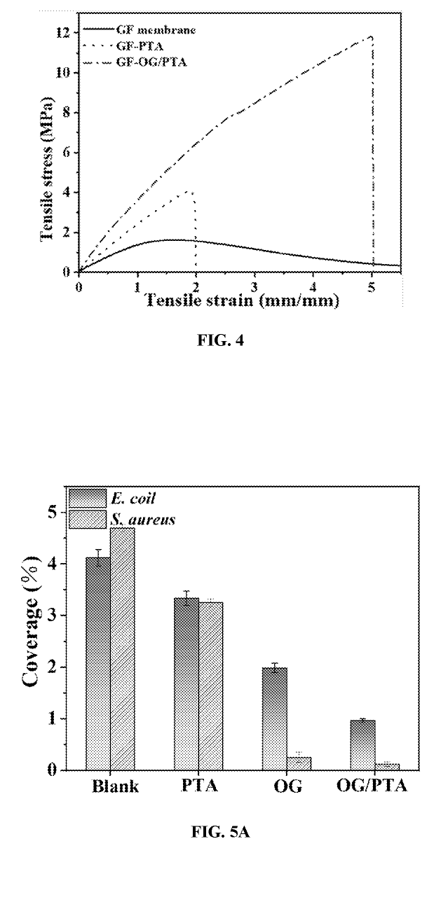

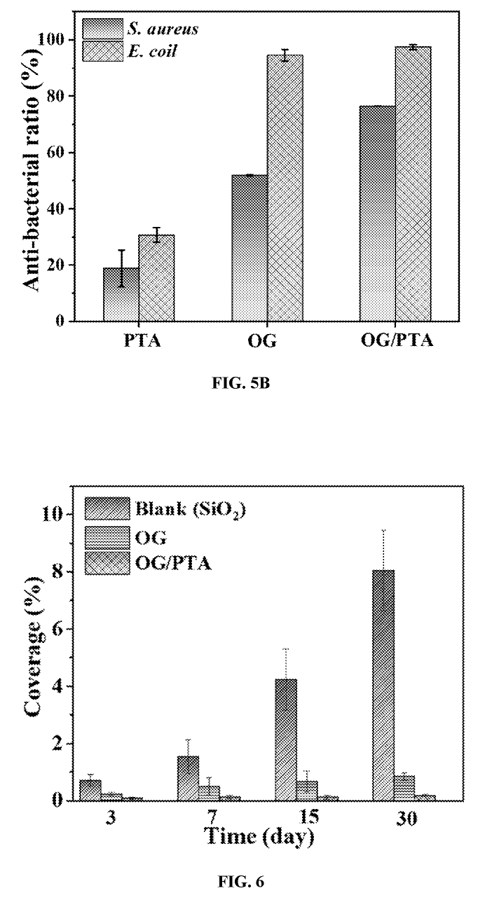

Characterizations: SEM confirms uniform coating with ~45 μm thickness (FIG. 2). Water contact angle indicates hydrophobicity (FIG. 3). Tensile performance of the coated substrate is increased to about three times that of the original GF membrane (FIG. 4).

### Comparative Example 1 Hydrogel-only Coating

A GF-PTA coating is prepared using only the hydrogel casting solution and the −80° C fixation plus thermal crosslinking process, without the OG layer or lubricant infusion.

### Example 2 Antibacterial Performance

Using LB agar plate methods, coatings on glass slides are evaluated against E. coli and S. aureus. The OG/PTA-coated slide exhibits markedly reduced bacterial coverage (e.g., S. aureus coverage ~0.9% and inhibition rate ~77%; E. coli coverage ~0.12% and inhibition rate ~97.45%), demonstrating strong anti-bacterial fouling performance.

### Example 3 Anti-algal Fouling Performance

Using Phaeodactylum tricornutum as a model alga for a 30-day adhesion test, the OG/PTA-coated slide shows very low algal coverage (~0.18%) compared with the blank slide (~8.04%) and OG-only slide (~0.84%), indicating excellent anti-algal biofouling performance.

### Example 4 Optimization of PVA/TA Ratio for Corrosion Resistance

Q235 steel substrates are coated with hydrogel layers prepared using 3 g PVA and 1-4 g TA (PTA-1 to PTA-4). Electrochemical tests in 3.5% NaCl solution (Tafel and EIS) indicate the optimal anti-corrosion performance at PVA:TA = 3:4 (PTA-4), which is used in subsequent experiments.

### Examples 5 - 7 VTMS Amount Variation in OG Formulation

Based on Example 4, VTMS amount is adjusted to 10 mg (OG/PTA-2), 15 mg (OG/PTA-3), and 20 mg (OG/PTA-4), while other preparation steps remain consistent.

### Example 8 Corrosion Resistance Comparison among OG/PTA Formulations

Electrochemical testing (Tafel and EIS in 3.5% NaCl) shows OG/PTA-3 provides the best corrosion protection, with an impedance magnitude reaching approximately 1.8×10⁵ Ω·cm², and superior Nyquist behavior. This is attributed to enhanced interfacial condensation/crosslinking leading to a denser protective structure.

Further comparison among OG/PTA-3, PTA-4, and bare Q235 indicates that the corrosion current density is reduced by about three orders of magnitude after applying the composite organogel lubricating coating.

### Example 9 Field Corrosion Test in Marine Environment

In a field exposure test (Zhoushan sea area) under tidal wet-dry conditions (immersion during high tide and exposure during low tide), OG/PTA-3 shows no obvious corrosion over a 15-day period compared with control samples, consistent with electrochemical results.

### 9. Industrial Applicability

The composite organogel lubricating coating provides a practical, non-toxic route to long-term anti-fouling and anti-corrosion performance, and is suitable for ship hull protection and related marine engineering applications.

What is claimed is:

1. A method for preparing a composite organogel lubricating coating, comprising:
(S1) adding poly(vinyl alcohol) (PVA) and tannic acid (TA) into an ethanol/water solution and heating until completely dissolved to obtain a hydrogel casting solution; immersing a cleaned substrate into the hydrogel casting solution, removing the substrate and cooling to fix the coating, and then performing thermal crosslinking until water is completely evaporated to obtain a gel coating;
(S2) mixing a vinyl-containing siloxane monomer, a vinyl-containing silicone oil, and a silane crosslinker containing Si—H bonds, and adding a platinum catalyst to promote an addition reaction to obtain an organogel casting solution;
(S3) uniformly applying the organogel casting solution obtained in (S2) onto a surface of the gel coating obtained in (S1), removing excess organogel casting solution and curing; infusing a lubricating liquid into a surface of the cured coating and removing excess lubricating liquid, thereby obtaining the composite organogel lubricating coating,
wherein in step (S1) a mass ratio of the PVA to the TA is 3:(1 to 4);
wherein in step (S2) the vinyl-containing siloxane monomer comprises vinyltrimethoxysilane, the vinyl-containing silicone oil comprises vinyl-terminated polydimethylsiloxane, the silane crosslinker comprises polymethylhydrosiloxane, and a mass ratio of the vinyl-terminated polydimethylsiloxane to the polymethylhydrosiloxane to the vinyltrimethoxysilane is 12:20:(1 to 4).

2. The method of claim 1, wherein, in step (S1), a volume ratio of ethanol to water in the ethanol/water solution is (4 to 6):(6 to 4).

3. The method of claim 1, wherein, in step (S1), the substrate coated with the hydrogel casting solution is cooled and fixed at −80° C.

4. The method of claim 1, wherein, in step (S1), the thermal crosslinking is performed in an oven at 40° C to 80° C for 0.5 hour to 1 hour.

5. The method of claim 1, wherein an amount of the platinum catalyst relative to the polymethylhydrosiloxane is 1:(80 to 120).

6. The method of claim 1, wherein, in step (S3), the curing is performed in an oven at 25° C to 40° C for 12 hours to 24 hours.

7. The method of claim 1, wherein, in step (S3), the lubricating liquid comprises polydimethylsiloxane, a perfluoropolyether, or a silicone oil.

8. A composite organogel lubricating coating prepared by the method of claim 1.

9. A method of marine antifouling and anticorrosion, comprising applying the composite organogel lubricating coating of claim 8 onto a surface of a ship hull for antifouling and anticorrosion protection.
